(19) United States
(12) Patent Application Publication
(10) Pub. No.: US 2024/0288011 A1
(43) Pub. Date: Aug. 29, 2024

(54) PROCESS QUANTITY MEASUREMENT DEVICE

(71) Applicant: Keyence Corporation, Osaka (JP)

(72) Inventors: Shinichi TSUKIGI, Osaka (JP); Yasunori KAWAGUCHI, Osaka (JP); Tomoyuki SAITO, Osaka (JP)

(73) Assignee: Keyence Corporation, Osaka (JP)

(21) Appl. No.: 18/411,085

(22) Filed: Jan. 12, 2024

(30) Foreign Application Priority Data
Feb. 28, 2023 (JP) 2023-029166

(51) Int. Cl. F15B 19/00; G01N 25/66

(52) U.S. Cl. CPC F15B 19/005; G01N 25/66

(57) ABSTRACT

A failure of a pneumatic device is prevented in advance by making it possible to determine whether or not compressed air supplied to the pneumatic device is sufficiently dried on the pneumatic device side. A process quantity measurement device includes: a pressure sensor generating a pressure signal corresponding to a pressure of a compressed gas passing through a pipe; a thermo-hygrometer measuring a temperature and a humidity of the compressed gas passing through the pipe; a user interface receiving an input of a pressure of the compressed gas in the supply source; and a dew point estimation unit that estimates a dew point in the supply source based on the pressure signal generated by the pressure measuring element, the temperature and the humidity measured by the thermo-hygrometer, and the pressure of the compressed gas in the supply source received via the user interface.

### CROSS-REFERENCE TO RELATED APPLICATIONS

The present application claims foreign priority based on Japanese Patent Application No. 2023-029166, filed Feb. 28, 2023, the contents of which are incorporated herein by reference.

### BACKGROUND OF THE INVENTION

### 1. Technical Field

The disclosure relates to a process quantity measurement device installed in a pipe through which a compressed gas passes.

### 2. Description of the Related Art

For example, pneumatic devices are used in manufacturing sites for manufacturing various products. In general, a pipe to which compressed air is supplied is connected to a pneumatic device, and a supply source of the compressed air is connected to the pipe.

In JP 2011-99361 A, a blower that generates compressed air lower in pressure than that of a compressor is installed in a supply source. Ann intake air temperature, an intake air humidity, and a pressure of the blower are measured to calculate a dew point of low-pressure air, and a measured temperature of a pipe that supplies the compressed air from the blower to a pneumatic device is compared with the dew point of the low-pressure air to determine the presence or absence of dew condensation. The low-pressure air is supplied from the blower in a case where it is determined that dew condensation does not occur, and high-pressure air of the compressor is mixed and supplied with the low-pressure air in a case where it is determined that dew condensation occurs.

Further, air compressed by the compressor is caused to flow to a dryer to be dried, and a dew point after the dryer is measured.

Meanwhile, as disclosed in JP 2011-99361 A, the supply source of compressed air supplies the compressed air after being dried by the dryer to the pneumatic device since a humidity increases if air is compressed. The dryer installed in the supply source is generally of a cooling type, and dew condensation is caused by lowering a temperature of the compressed air to a dew point under a set pressure to remove moisture in the compressed air.

However, the temperature of the compressed air rises, and further, an ambient temperature rises in the summer season. Thus, there is a case where a cooling capacity of the dryer is insufficient. When the cooling capacity of the dryer is insufficient, it is difficult to lower the temperature of the compressed air to the dew point, and it is difficult to sufficiently dry the compressed air. Further, there is also a case where it is difficult to dry the compressed air due to a failure of the dryer. When the compressed air insufficiently dried is supplied to the pneumatic device, water condenses and accumulates in the pneumatic device when a pressure drops in the pneumatic device and the temperature of the air decreases due to adiabatic expansion, which causes a failure of the pneumatic device.

In this regard, in JP 2011-99361 A, the dew point of the low-pressure air is calculated by measuring the intake air temperature, the intake air humidity, and the pressure of the blower, and the dew point after the dryer is measured, but these are calculation and measurement in the supply source. Whether or not the compressed air is dried is a matter that causes a problem on the pneumatic device side as a supply destination, and it is difficult to determine on the pneumatic device side that the dryer has an insufficient capacity or has failed by a method in JP 2011-99361 A.

### SUMMARY OF THE INVENTION

The disclosure has been made in view of such a point, and an object thereof is to prevent a failure of a pneumatic device in advance by making it possible to determine whether or not compressed air supplied to the pneumatic device is sufficiently dried on the pneumatic device side.

In order to achieve the above object, according to one embodiment, a process quantity measurement device installed in a supply pipe through which a compressed gas supplied from a supply source passes can be assumed. The process quantity measurement device includes: a pressure measuring element that generates a pressure signal corresponding to a pressure of the compressed gas passing through a pipe connected to the supply pipe; a thermo-hygrometer that measures a temperature and a humidity of the compressed gas passing through the pipe; and a reception unit that receives an input of a pressure of the compressed gas in the supply source. The process quantity measurement device further includes: a dew point estimation unit that estimates a dew point in the supply source based on the pressure signal generated by the pressure measuring element, the temperature and the humidity measured by the thermo-hygrometer, and the pressure of the compressed gas in the supply source received via the reception unit; and a display unit that displays the dew point estimated by the dew point estimation unit.

According to this configuration, the dew point of the compressed gas is estimated by the process quantity measurement device installed at a place distant from the supply source, and the estimated dew point is displayed on the display unit. Therefore, for example, in a case where the compressed air is supplied to a pneumatic device, whether the operation is normal at a set dew point can be determined not on the supply source side but on the pneumatic device side.

An ON/OFF signal may be generated based on the dew point estimated by the dew point estimation unit and a preset threshold and output. Further, a determination result based on the dew point estimated by the dew point estimation unit and a preset threshold can be displayed on the display unit. As a result, it is possible to compare a set dew point of a dryer with a dew point on the pneumatic device side to find out a failure or an insufficient capacity of the dryer.

The pressure measuring element and the thermo-hygrometer may be accommodated in a common housing. Further, in a case where a flow rate measuring element for measuring a flow rate of the compressed gas in the pipe is further provided, the flow rate measuring element can also be accommodated in the housing. That is, since all of a pressure measurement point, a temperature measurement point, and a humidity measurement point can be brought close to each other, the estimation accuracy of the dew point on the pneumatic device side is improved.

The dew point estimation unit may be configured not to execute dew point estimation processing when the flow rate measured by the flow rate measuring element is equal to or less than a predetermined flow rate. Further, the display unit may be configured not to display the dew point when the flow rate measured by the flow rate measuring element is equal to or less than a predetermined flow rate. That is, estimation accuracy of the dew point decreases in a low flow rate time when the flow rate of the compressed gas is low, and thus, it is not necessary to present a dew point with low reliability by not executing the dew point estimation processing or display in the low flow rate time.

The dew point estimation unit can also correct the dew point estimated by weighting the flow rate measured by the flow rate measuring element. That is, the accuracy can be further enhanced as the flow rate of the compressed gas passing through the pipe increases, and thus, it is possible to estimate the dew point with high accuracy by weighting a measurement value with a higher flow rate.

The display unit may display the temperature and the humidity measured by the thermo-hygrometer. Further, a storage unit that stores the dew point estimated by the dew point estimation unit in association with a time when the dew point has been estimated may be further provided, whereby time-series data of the dew point can be acquired.

As described above, the dew point of the compressed air can be estimated and displayed by the process quantity measurement device installed in the pipe through which the compressed gas supplied from the supply source passes. Thus, whether or not the compressed air supplied to the pneumatic device is sufficiently dried can be determined on the pneumatic device side, and a failure of the pneumatic device due to dew condensation of the compressed air can be prevented in advance.

### BRIEF DESCRIPTION OF THE DRAWINGS

FIG. 1 is a diagram schematically illustrating a factory in which a process quantity measurement device according to an embodiment of the invention is used;

FIG. 2 is a view for describing the time when the process quantity measurement device is operated;

FIG. 3 is a front view of the process quantity measurement device;

FIG. 4 is a longitudinal sectional view of the process quantity measurement device in which a valve is open;

FIG. 5 is a longitudinal sectional view of the process quantity measurement device in which the valve is closed;

FIG. 6 is a block diagram of the process quantity measurement device;

FIG. 7 is a sectional view illustrating an arrangement structure of a thermo-hygrometer; and

FIG. 8 is a view illustrating an example of a dew point display screen.

### DETAILED DESCRIPTION

Hereinafter, an embodiment of the invention will be described in detail with reference to the drawings. Note that the following description of the preferred embodiment is merely an example in essence, and is not intended to limit the invention, its application, or its use.

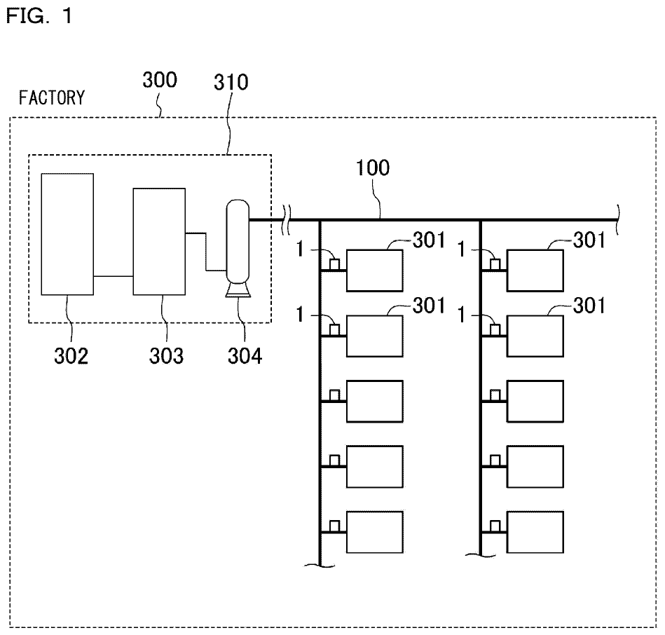

FIG. 1 is a diagram schematically illustrating a factory 300 in which a process quantity measurement device 1 according to the embodiment of the invention is used. In the factory 300, a plurality of apparatuses 301 configured to perform assembling, transporting, member processing, and the like of products are installed. The apparatuses 301 are provided with an air blowing device, an air cylinder device, a suction conveying device, a seating device, and the like, which use compressed air as a compressed gas and can be referred to as pneumatic devices as a type of fluid device, and one or a plurality of pneumatic devices may be provided in one apparatus 301.

The compressed air is obtained using a compressor 302 and a dryer 303. That is, the compressor 302 is a device for sucking air and performing compression to a predetermined pressure equal to or higher than atmospheric pressure. Since a humidity of the compressed air compressed by compressor 302 has increased, the compressed air is supplied to the dryer 303 to be dried. The dryer 303 includes a cooling device, and the cooling device exerts a cooling capacity for cooling the compressed air. An air tank 304 is connected to the downstream side of the dryer 303. The compressed air dried through the dryer 303 is temporarily stored in the air tank 304. A supply pipe 100 extending to the apparatuses 301 is connected to an outlet of the air tank 304. The supply pipe 100 has a plurality of branch portions, and is connected to the respective apparatuses 301 on the downstream side of the branch portions. In this manner, the compressed air obtained by one compressor 302 and one dryer 303 passes through the supply pipe 100, and then, is supplied to the plurality of apparatuses 301 to be used in the respective apparatuses 301.

Note that the compressor 302, the dryer 303, and the air tank 304 may be installed inside the factory 300, installed outside the factory 300, or installed at a place distant from the factory 300. The compressor 302, the dryer 303, and the air tank 304 constitute a supply source 310 of the compressed air.

The process quantity measurement device 1 is a device for measuring a plurality of types of process quantity of a working gas (compressed air) used in the pneumatic device included in the apparatus 301. Examples of the types of the process quantity include a flow rate, a pressure, and the like, but may include a state quantity other than these. Downstream parts of the supply pipe 100 with respect to the branch portions are connected to the respective apparatuses 301, and the process quantity measurement device 1 is installed at each of the downstream parts of the supply pipe 100 with respect to the branch portions.

Since the process quantity measurement device 1 is installed for each of the apparatuses 301, the process quantity measurement device 1 can measure a flow rate and a pressure of the compressed air used in one apparatus 301. In the case of the apparatus 301 provided with only one pneumatic device, a flow rate of the compressed air used in the one pneumatic device is measured by the process quantity measurement device 1. Further, in the case of the apparatus 301 provided with a plurality of pneumatic devices, a total flow rate of the compressed air used in the plurality of pneumatic devices is measured by the process quantity measurement device 1.

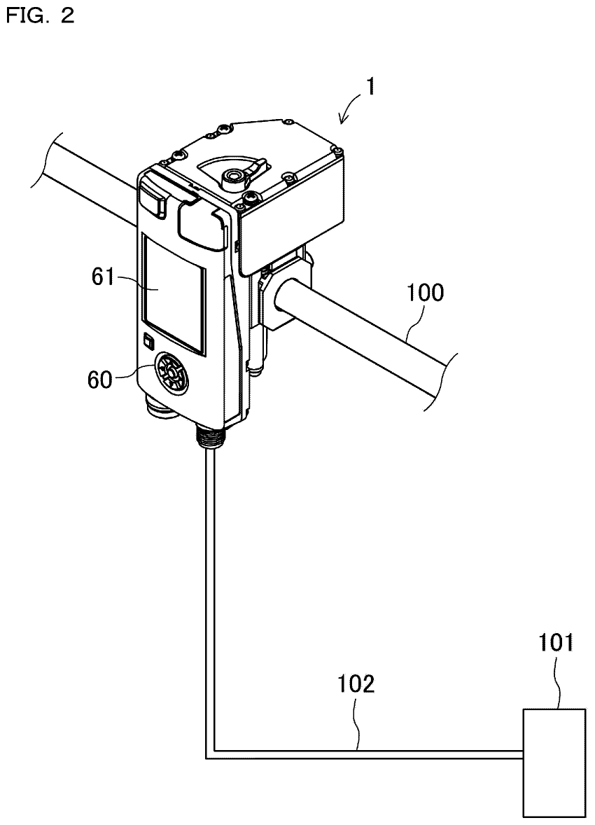

As illustrated in FIG. 2, the process quantity measurement device 1 is installed in the supply pipe 100 and operated. When the process quantity measurement device 1 is operated, a power supply unit 101 and the process quantity measurement device 1 are connected by a connection line 102. Power for operating the process quantity measurement device 1 is supplied from the power supply unit 101. Further, a control signal is output from the power supply unit 101. The control signal output from the power supply unit 101 is input to the process quantity measurement device 1 via the connection line 102. In this case, the measured flow rate is sequentially stored in the process quantity measurement device 1. The measured flow rate may be transmitted to the outside. Note that the process quantity measurement device 1 can also be operated in the state of being connected to a personal computer or the like although not illustrated. In this case, information such as the measured flow rate can be sequentially stored in a PC 120.

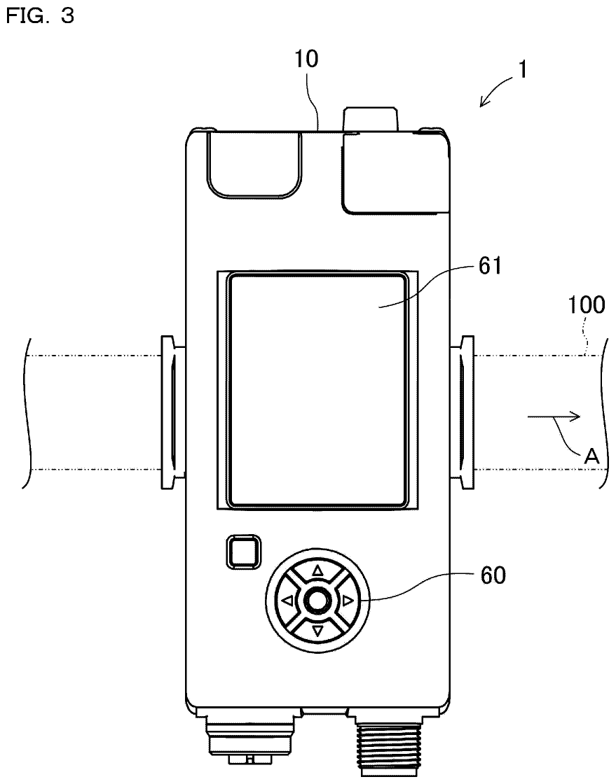

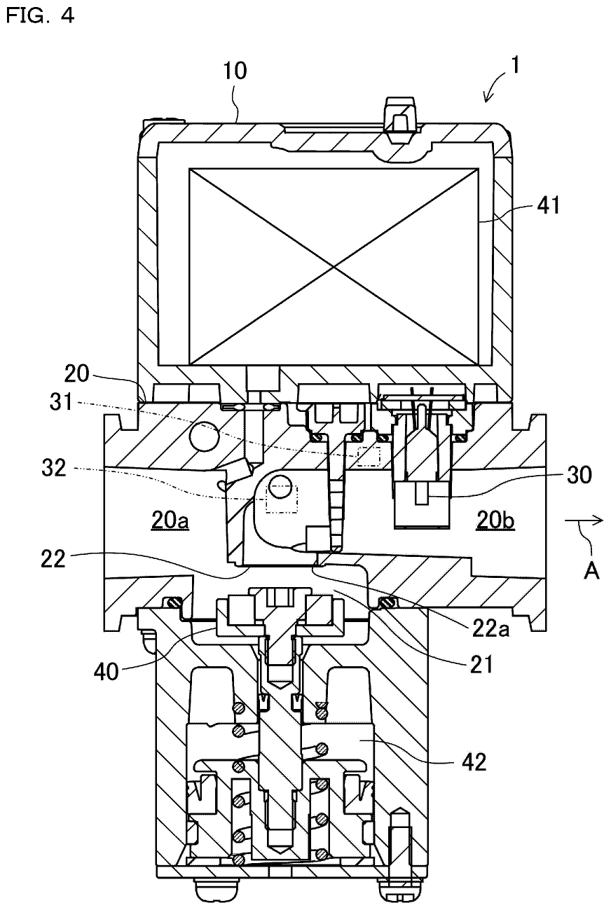

FIG. 3 is a view of the process quantity measurement device 1 as viewed from the front (a front surface), and FIG. 4 is a longitudinal sectional view of the process quantity measurement device 1. The process quantity measurement device 1 includes a housing 10 that is long in an up-down direction. In the description of the present embodiment, the left side in FIGS. 3 and 4 is referred to as the left side of the process quantity measurement device 1, and the right side in FIGS. 3 and 4 is referred to as the right side of the process quantity measurement device 1. However, this is merely defined to facilitate the description of the embodiment, and does not limit directions when the process quantity measurement device 1 is used.

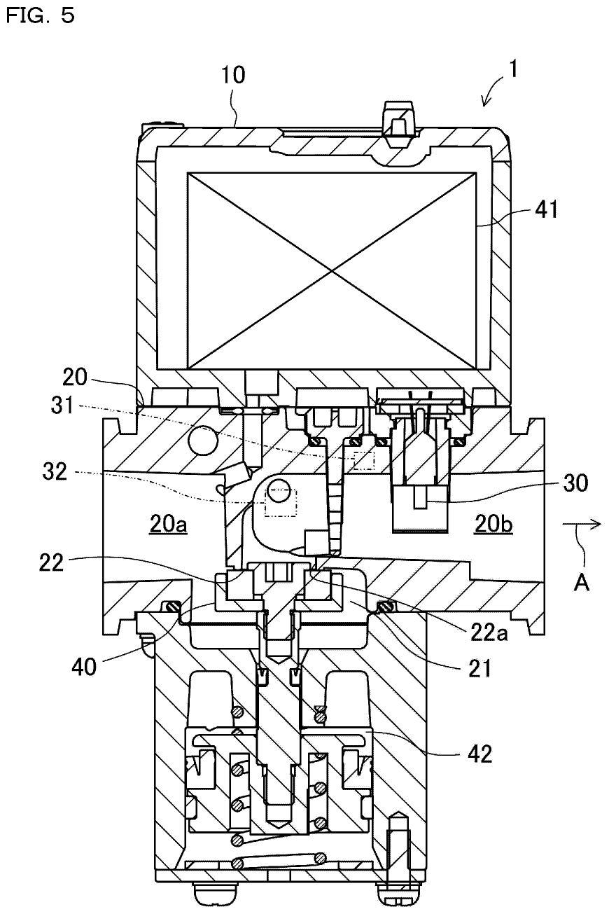

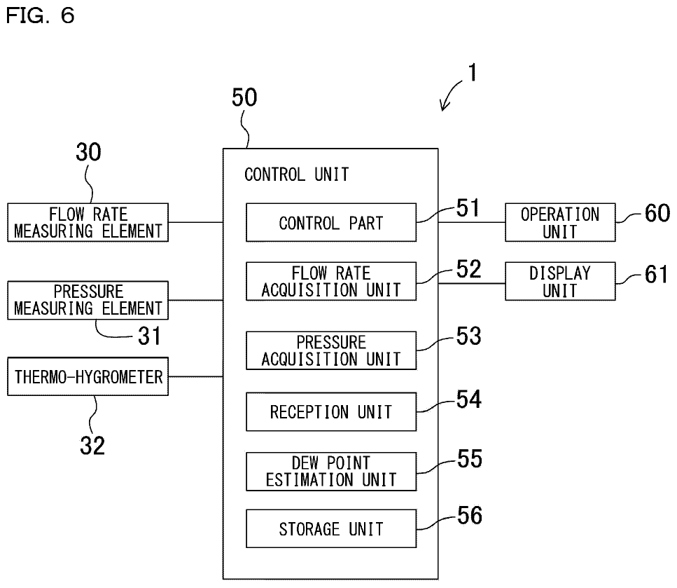

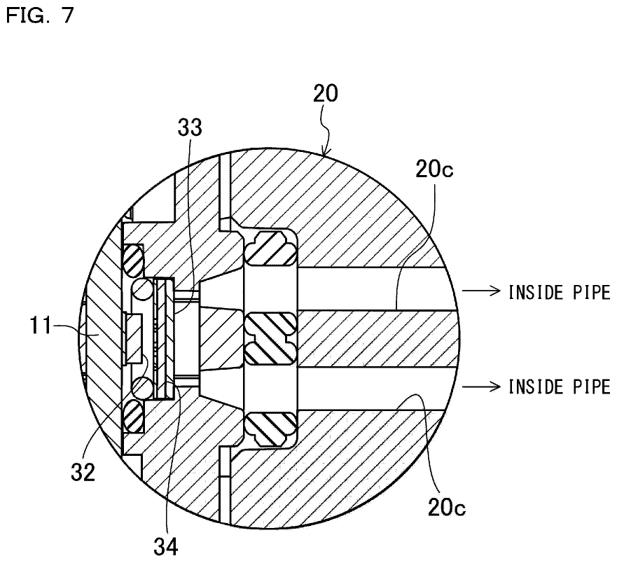

The compressed air flows in a direction of arrow A (a direction from the left side to the right side in FIG. 3). As illustrated in FIGS. 4 and 5, the process quantity measurement device 1 includes a pipe 20 that forms a flow path of the compressed air, a flow rate measuring element 30 that generates a measurement signal corresponding to the flow rate of the compressed air passing through the pipe 20, a pressure measuring element 31 such as a pressure sensor that generates a pressure signal corresponding to a pressure of the compressed air passing through the pipe 20, and a thermo-hygrometer 32 that measures a temperature and a humidity of the compressed air passing through the pipe 20. The flow rate measuring element 30, the pressure measuring element 31, and the thermo-hygrometer 32 are also illustrated in a block diagram of FIG. 6. As a hygrometer constituting the thermo-hygrometer 32, for example, a capacitive type or a resistive type can be used. The thermo-hygrometer 32 is also illustrated in FIG. 7, and is mounted on a substrate 11 accommodated in the housing 10. Note that a housing in which a display unit is provided may be provided separately from the housing in which the substrate 11 is accommodated.

The pipe 20 extends in a left-right direction at an intermediate portion of the housing 10 in the up-down direction. A left end (an upstream end) of the pipe 20 is opened to the outside from a left side surface of the housing 10, and is connected to the supply pipe 100 on the upstream side of the process quantity measurement device 1. A right end (a downstream end) of the pipe 20 is opened to the outside from a right side surface of the housing 10, and is connected to the supply pipe 100 on the downstream side of the process quantity measurement device 1.

The flow rate measuring element 30, the pressure measuring element 31, and the thermo-hygrometer 32 can be brought close to each other. The pressure measuring element 31 is disposed to be in contact with the compressed air passing through the pipe 20, whereby it possible to generate a pressure signal corresponding to the pressure of the compressed air passing through the pipe 20. Further, the thermo-hygrometer 32 is also disposed to be in contact with the compressed air passing through the pipe 20, whereby it is possible to measure the temperature and the humidity of the compressed air passing through the pipe 20. The temperature and the humidity measured by the thermo-hygrometer 32 are input to the dew point estimation unit 55. Note that the control unit 50 may be provided with a temperature and humidity acquisition unit although not illustrated. In this case, the temperature and humidity acquisition unit acquires a temperature and a humidity based on a signal output from the thermo-hygrometer 32, and inputs the temperature and the humidity to the dew point estimation unit 55.

FIG. 7 is a sectional view illustrating an arrangement structure of the thermo-hygrometer 32. The pipe 20 is provided with two air channels 20c extending until reaching a detection surface of the thermo-hygrometer 32. The air channels 20c communicate with a part where a pressure difference occurs due to the drift in the flow path formed by the pipe 20, and the compressed air passing through the pipe 20 is guided to the thermo-hygrometer 32 by the air channel 20c. A first cover member 33 and a second cover member 34, each of which is made of a moisture-permeable sheet, are provided in front of the detection surface of the thermo-hygrometer 32. The first cover member 33 is configured using a moisture-permeable filter that is rougher than that of the second cover member 34. Since the first cover member 33 and the second cover member 34 are provided, it is possible to suppress drain and oil mist contained in the compressed air from adhering to the detection surface of the thermo-hygrometer 32, and deterioration of measurement accuracy can be avoided. Note that the thermo-hygrometer 32 may be disposed inside the pipe 20.

The flow rate measuring element 30 illustrated in FIG. 4 is a thermal flow rate measuring element. The flow rate measuring element 30 has a configuration in which a pair of plate-shaped resistance temperature detectors is aligned in parallel, and both the resistance temperature detectors are arranged at positions where drift is uniform in the pipe 20. Since the thermal flow rate measuring element 30 is known in the related art, detailed description thereof will be omitted.

Further, an ultrasonic flow rate measuring element may be used instead of the thermal flow rate measuring element 30. Since this ultrasonic flow rate measuring element is also known in the related art, detailed description thereof will be omitted. In the case of using the ultrasonic flow rate measuring element 30, it is necessary to provide the pressure measuring element 31 (illustrated in FIG. 6) that measures the pressure of the compressed air in the pipe 20 in order to measure a mass flow rate of the compressed air.

The process quantity measurement device I also includes a valve 40 constituting a shut-off valve. That is, a valve accommodating space 21 is formed below an intermediate portion of the pipe 20 in a flow direction. The valve accommodating space 21 communicates with a space 20a on the upstream side of the valve accommodating space 21 in the pipe 20. A partition wall 22 is provided above the valve accommodating space 21. The partition wall 22 is a part that partitions the valve accommodating space 21 and a space 20b on the downstream side of the valve accommodating space 21 in the pipe 20. A communication hole 22a that allows the valve accommodating space 21 and the space 20b on the downstream side to communicate with each other is formed in a lower portion of the partition wall 22.

The valve 40 is disposed so as to be movable in the up-down direction inside the valve accommodating space 21. The valve 40 in the state of being moved upward comes into contact with a peripheral edge portion of the communication hole 22a from below to close the communication hole 22a, and the valve 40 is closed at this position. On the other hand, the valve 40 in the state of being moved downward is separated downward from the peripheral edge portion of the communication hole 22a so that the communication hole 22a is opened, and the valve 40 is open at this position.

An operation mechanism of the valve 40 is a pilot type and uses a keep solenoid. The pilot valve and the keep solenoid are incorporated in, for example, a solenoid module 41 or the housing 10. A pressure in the space 20a of the pipe 20 and the atmospheric pressure are guided to the solenoid module 41 via a channel (not illustrated), and an operating chamber 42 performs operation control by switching between two types of the space 20a and the atmospheric pressure by the pilot valve.

The keep solenoid of the solenoid module 41 includes a plunger and a coil, and is configured to allow a current to flow through the coil only at the time of moving the plunger, and to be capable of maintaining a position of the plunger without allowing the current to flow through the coil after the plunger is moved to a desired position. Since the pilot valve is open and closed by the keep solenoid, a desired pressure is supplied to the operating chamber 42, and the valve 40 can be moved in the up-down direction.

FIG. 6 is the block diagram of the process quantity measurement device 1. The process quantity measurement device 1 includes the control unit 50. The control unit 50 includes a control part 51, a flow rate acquisition unit 52, a pressure acquisition unit 53, a reception unit 54, a dew point estimation unit 55, and a storage unit 56. Further, the control unit 50 includes a built-in real-time clock, a built-in battery, and the like (not illustrated) and can store various types of measurement data and the like in the storage unit 56 in association with the date and time. As a result, various graph display, numerical value display, conversion display, and the like can be performed based on accumulated data without constantly reading data. Further, the accumulated data stored in the storage unit 56 can be output to an external device.

The control part 51, the flow rate acquisition unit 52, the pressure acquisition unit 53, the reception unit 54, and the dew point estimation unit 55 are configured using a microcomputer, an input/output interface, a communication module, and the like that operate according to a program stored in advance in the storage unit 56 or the like. All of the control part 51, the flow rate acquisition unit 52, the pressure acquisition unit 53, the reception unit 54, and the dew point estimation unit 55 may be configured by the same microcomputer or the like, or may be configured by different microcomputers or the like.

Furthermore, the process quantity measurement device 1 further includes an operation unit 60 and a display unit 61. The operation unit 60 includes a plurality of operation buttons and the like to be operated by a user, and is disposed in a lower part of the front surface of the housing 10 as illustrated in FIG. 3. The user's operation on the operation unit 60 is received by the reception unit 54 of the control unit 50. For example, the user can input a pressure of the compressed air in the supply source 310 by operating the operation unit 60. In this case, when the user grasps the pressure of the compressed air in the supply source 310 with another measuring instrument or the like and then operates the operation unit 60 to perform a pressure input operation, an input value is received by the reception unit 54 such as user interface. The received value of the pressure is stored in the storage unit 56 and input to the dew point estimation unit 55.

The display unit 61 is configured using, for example, an organic EL display, a liquid crystal display, or the like, and is controlled by the control part 51. The display unit 61 is disposed above the operation unit 60 on the front surface of the housing 10. A shape of the display unit 61 is not particularly limited, but is a shape that is long in the up-down direction in this embodiment. Note that a display content of the display unit 61 can be displayed on a monitor of a personal computer in the case of an operation mode using the personal computer.

The control part 51 controls the keep solenoid of the solenoid module 41 based on a signal input from the outside or a signal corresponding to a leakage determined by the control part 51. The valve 40 can be switched from an open state to a closed state or from the closed state to the open state by controlling the keep solenoid.

The flow rate acquisition unit 52 is a part that a measurement signal generated by the flow rate measuring element 30 and acquires a flow rate based on the measurement signal. In the case of the thermal flow rate measuring element 30, when a measurement signal related to an amount of heat dissipation from the resistance temperature detector is generated and the flow rate acquisition unit 52 receives the measurement signal related to the amount of heat dissipation, a flow rate of the compressed air in the pipe 20 can be calculated and acquired using a relational expression between the amount of heat dissipation and the flow rate. In the case of the ultrasonic flow rate measuring element, for example, two ultrasonic elements are provided, the flow rate acquisition unit 52 can acquire a propagation time difference between these two ultrasonic elements, and a flow rate of the compressed air in the pipe 20 can be calculated and acquired using the acquired propagation time difference. Further, an instantaneous flow rate at a certain time point can be acquired by the flow rate acquisition unit 52. An integrated flow rate can be calculated by integrating the instantaneous flow rate for a certain period.

The pressure acquisition unit 53 is a part that receives a measurement signal generated by the pressure measuring element 31 and acquires a pressure based on the measurement signal. The pressure measuring element 31 is configured using, for example, a strain gauge, a capacitance type, or the like, and is configured to convert the pressure of the compressed air into an electric signal and output the electric signal. In this case, the pressure acquisition unit 53 can acquire the pressure based on the electric signal output from the pressure measuring element 31.

The dew point estimation unit 55 estimates a dew point in the supply source 310 based on the pressure signal generated by the pressure measuring element 31, the temperature and the humidity measured by the thermo-hygrometer 32, and the pressure of the compressed air in the supply source 310 received via the reception unit 54 such as user interface. When the dew point is to be estimated, a known calculation formula may be used, and the dew point in the supply source is obtained by putting the pressure signal generated by the pressure measuring element 31, the temperature and the humidity measured by the thermo-hygrometer 32, and the pressure of the compressed air in the supply source 310 received via the reception unit 54 into the calculation formula.

The dew point estimation unit 55 is configured to correct the estimated dew point by weighting the flow rate measured by the flow rate measuring element 30. That is, when the flow rate fluctuates transiently, the pressure changes due to a pressure loss in a flow path of each portion, and the humidity also changes accordingly. The pressure measuring element 31 has fast measurement responsiveness, but a space in which the thermo-hygrometer 32 is disposed has a split flow configuration, and thus, replacement of air in the space in which the thermo-hygrometer 32 is disposed is slow in a low flow rate time so that responsiveness is slow. Since such a difference in the responsiveness becomes a measurement error, the accuracy becomes higher when weight in a high flow rate time when the responsiveness is fast is increased as much as possible. That is, the accuracy can be further enhanced as the flow rate of the compressed air passing through the pipe 20 increases, and thus, it is possible to estimate the dew point with high accuracy by weighting a measurement value with a higher flow rate. For example, the flow rate measured by the flow rate measuring element 30 can be weighted by using a calculation formula of (instantaneous flow rate×dew point)/integrated flow rate.

The dew point estimated by the dew point estimation unit 55 is stored in the storage unit 56 in association with a time when the dew point has been estimated. As a result, time-series data of the estimated dew point can be acquired.

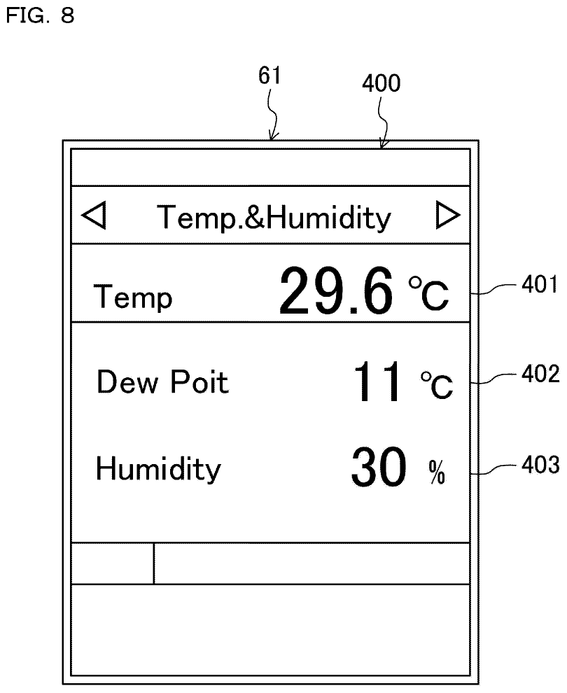

The dew point estimated by the dew point estimation unit 55 is displayed on the display unit 61. FIG. 8 illustrates a dew point display screen 400 displaying the dew point. The dew point display screen 400 is generated by the control part 51 and displayed on the display unit 61. The dew point display screen 400 is provided with a temperature display region 401 displaying the temperature of the compressed air passing through the pipe 20, a dew point display region 402 displaying the dew point estimated by the dew point estimation unit 55, and a humidity display region 403 displaying the humidity of the compressed air passing through the pipe 20. The temperature and the humidity measured by the thermo-hygrometer 32 are displayed in the temperature display region 401 and the humidity display region 403, respectively. The temperature display region 401 and the humidity display region 403 may be provided as necessary or may be omitted. Further, at least one of the flow rate acquired by the flow rate acquisition unit 52 or the pressure acquired by the pressure acquisition unit 53 may be displayed on the dew point display screen 400.

It is also possible to adopt a configuration in which a determination result based on the dew point estimated by the dew point estimation unit 55 and a preset threshold is displayed on the display unit 61. For example, in a case where the dew point estimated by the dew point estimation unit 55 exceeds the threshold, the fact that the dew point exceeds the threshold is displayed on the display unit 61 using a symbol, an icon, a character, or the like. Further, when the dew point estimated by the dew point estimation unit 55 is equal to or less than the threshold, the fact that the dew point is equal to or less than the threshold may be displayed on the display unit 61 using a symbol, an icon, a character, or the like.

The dew point estimation unit 55 is configured to acquire the flow rate measured by the flow rate measuring element 30 and not to execute dew point estimation processing when the acquired flow rate is equal to or less than a predetermined flow rate. That is, estimation accuracy of the dew point decreases in the low flow rate time when the flow rate of the compressed air is low, and thus, it is not necessary to present a dew point with low reliability by not executing the dew point estimation processing in the low flow rate time.

Further, for the same reason, the display unit 61 is configured not to display the dew point when the flow rate measured by the flow rate measuring element 30 is equal to or less than a predetermined flow rate. That is, the dew point estimation unit 55 may estimate a dew point regardless of the flow rate of the compressed air, but it is not necessary to present a dew point with low reliability by not executing dew point display processing in the low flow rate time since the estimation accuracy of the dew point decreases in the low flow rate time when an error in the low flow rate time increases due to clogging of the moisture-permeable sheet.

Further, the control part 51 of the process quantity measurement device 1 generates an ON/OFF signal based on the dew point estimated by the dew point estimation unit 55 and a preset threshold, and outputs the ON/OFF signal to the outside of the process quantity measurement device 1. As a result, the dew point estimated by the dew point estimation unit 55 can be compared with a set dew point of the dryer 303, and thus, it is possible to grasp a failure or an insufficient capacity of the dryer 303. For example, it is also possible to automatically determine the failure or insufficient capacity of the dryer 303 based on the dew point output from the process quantity measurement device 1.

### Functions and Effects of Embodiment

As described above, the process quantity measurement device 1 according to the embodiment of the invention can estimate the dew point in the supply source 310 by the dew point estimation unit 55 based on the pressure signal generated by the pressure measuring element 31, the temperature and the humidity measured by the thermo-hygrometer 32, and the pressure of the compressed air in the supply source 310 received via the reception unit 54, and cause the display unit 61 to display the dew point estimated by the dew point estimation unit 55. As a result, it is possible to determine whether or not the compressed air is sufficiently dried, so that it is possible to prevent a failure of the pneumatic device due to dew condensation of the compressed air.

The above-described embodiment is merely an example in all respects, and should not be construed as limiting. Furthermore, all modifications and changes belonging to the equivalent range of the claims fall within the scope of the invention.

As described above, the process quantity measurement device according to the disclosure can be used, for example, in the factory in which various pneumatic devices are installed and the like.

What is claimed is:

1. A process quantity measurement device for measuring a plurality of types of process quantity related to compressed gas, the process quantity measurement device comprising:
a pipe in which compressed gas pass through;
a pressure sensor configures to generate a pressure signal corresponding to a pressure of the compressed gas passing through the pipe;
a thermo-hygrometer configured to measure a temperature and a humidity of the compressed gas passing through the pipe;
a user interface configured to receive an input of a pressure of the compressed gas in the supply source;
a dew point estimation unit that estimates a dew point in the supply source based on the pressure signal generated by the pressure sensor, the temperature and the humidity measured by the thermo-hygrometer, and the pressure of the compressed gas in the supply source received via the user interface; and
a display unit that displays the dew point estimated by the dew point estimation unit.

2. The process quantity measurement device according to claim 1, wherein an ON/OFF signal is generated based on the dew point estimated by the dew point estimation unit and a preset threshold and output.

3. The process quantity measurement device according to claim 2, wherein a determination result based on the dew point estimated by the dew point estimation unit and a preset threshold is displayed on the display unit.

4. The process quantity measurement device according to claim 1, wherein the pressure sensor and the thermo-hygrometer are accommodated in a common housing.

5. The process quantity measurement device according to claim 4, further comprising a flow rate measuring element configured to measure a flow rate of the compressed gas in the pipe,
wherein the flow rate measuring element is accommodated in the housing.

6. The process quantity measurement device according to claim 5, wherein the dew point estimation unit is configured not to execute dew point estimation processing when the flow rate measured by the flow rate measuring element is equal to or less than a predetermined flow rate.

7. The process quantity measurement device according to claim 5, wherein the display unit is configured not to display the dew point when the flow rate measured by the flow rate measuring element is equal to or less than a predetermined flow rate.

8. The process quantity measurement device according to claim 5, wherein the dew point estimation unit corrects the estimated dew point by weighting the flow rate measured by the flow rate measuring element.

9. The process quantity measurement device according to claim 1, wherein the display unit displays the temperature and the humidity measured by the thermo-hygrometer.

10. The process quantity measurement device according to claim 1, further comprising a storage unit that stores the dew point estimated by the dew point estimation unit in association with a time when the dew point has been estimated.
